(19) United States
(12) Patent Application Publication
(10) Pub. No.: US 2024/0334904 A1
(43) Pub. Date: Oct. 10, 2024

(54) Pet Hair Comb and Hair Removing Method Thereof

(71) Applicant: Shuiyou Zeng, Shanwei City (CN)

(72) Inventor: Shuiyou Zeng, Shanwei City (CN)

(21) Appl. No.: 18/375,980

(22) Filed: Oct. 2, 2023

(30) Foreign Application Priority Data
Apr. 4, 2023 (CN) 202330179161.1
Apr. 4, 2023 (CN) 202330179162.6

(51) Int. Cl. A01K 13/00; A46B 15/00; A47L 7/00; A47L 9/00; A47L 9/06

(52) U.S. Cl. CPC A01K 13/002; A46B 15/0053; A46B 15/0081; A47L 7/0066; A47L 9/0072; A47L 9/0613; A47L 9/0653; A46B 2200/1093

(57) ABSTRACT

A pet hair comb includes an installation shell body having an air duct, a grooming assembly, and a hair scraping assembly, wherein a relative movement between the hair scraping assembly and the grooming assembly allows the hair scraping assembly to scrape down the pet hair on the grooming assembly, wherein the pet hair comb has an air pressure adjusting port which is configured to be switched between an unblocked sate and a blocked state when the air duct is in a negative pressure state for sucking the pet hair, so as to adjust an air pressure in the air duct for facilitating the removal of the pet hair on the comb.

### CROSS REFERENCE OF RELATED APPLICATION

The present invention is a non-provisional application that claims priority under 35 U.S.C. § 119 to China application number CN202330179161.1, filing date 04/04/2023, and China application number CN202330179162.6, filing date 04/04/2023, wherein the entire content of which is expressly incorporated herein by reference.

### BACKGROUND OF THE PRESENT INVENTION

### Field of Invention

The present invention relates to the field of pet grooming technology, and more particularly to a pet hair comb and hair removing method thereof.

### Description of Related Arts

Pet supplies have increasingly entered people's lives, such as comb brushes used for grooming pets. Some conventional comb brushes are able to remove pet's loose coat during the grooming process. During the process of removing loose hair, a conventional comb brush generally uses its comb needles to comb the hair and remove the loose hair. Most of the removed loose hair is tangled on the comb needles. A user may manually remove the pet's hair from the comb needles. Some comb brushes are equipped with hair pushing plates. The user can press a pressing plate connected to the hair pushing plate to push the loose hair tangled on the comb needles away from the comb needles. After pushing the loose hair away from the comb needles, the comb needles can be used again for grooming and removing loose hair.

However, during the combing process or during the process of separating the loose hair from the comb needles using the hair pushing plate, there may be loose hair floating in the air or remaining on the comb, requiring secondary cleaning of the loose hair. Therefore, the conventional comb is connected to a suction device during use to suck the loose hair during the combing and hair removing processes.

However, in actual use, there are still some problems with the conventional comb. Specifically, when suctioning the loose hair, an internal air pressure of the comb remains basically unchanged. Correspondingly, a pulling force generated by the suction device on the loose hair remains basically unchanged in terms of magnitude and direction, that is, the loose hair is continuously pulled in a specific direction with a specific force, which may cause the loose hair to become more tightly wrapped and tangled on the comb needles, making it difficult to pull and separate the loose hair away from the comb.

### SUMMARY OF THE PRESENT INVENTION

The invention is advantageous in that it provides a pet hair comb and hair removing method thereof, wherein the pet hair comb is formed with an air pressure adjusting port which is used to communicate an air duct of the pet hair comb to the outer side, wherein during the use of the pet hair comb, the air pressure adjusting port is switched between a blocked state and an unblocked state, causing an air pressure inside the air duct of the pet hair comb to change repeatedly. Accordingly, during the use of the pet hair comb, a pulling force on the loose hair is alternately loosened and tightened, and the direction of the pulling force on the loose hair is repeatedly adjusted, which helps to remove the loose hair from the pet hair comb.

Another advantage of the present invention is to provide a pet hair comb and hair removing method thereof, wherein in the process of scraping down the loose hair with the hair scraping element of the pet hair comb, the air pressure adjusting port is blocked, resulting in a decrease in air pressure inside the air duct of the pet hair comb and an increase in the pulling force on the loose hair. In this way, the state of the air pressure adjusting port and the state of the hair scraping element cooperate with each other for removing the loose hair. During the process of scraping down the loose hair, the pulling force on the loose hair increases, while during a resetting process of the pet hair comb, the pulling force on the loose hair decreases, so as to facilitate the removal of the loose hair from the pet hair comb.

In order to achieve the above-mentioned at least one advantage or other advantages and objectives, according to one aspect of the present invention, the present invention provides a pet hair comb, comprising:
an installation shell body having an air duct;
a grooming assembly installed on the installation shell body; and
a hair scraping assembly, wherein a relative movement between the hair scraping assembly and the grooming assembly allows the hair scraping assembly to scrape down the pet hair on the grooming assembly, wherein the pet hair comb has an air pressure adjusting port which is configured to be switched between an unblocked sate in which the air pressure adjusting port communicates the air duct to an outer side and a blocked state in which the air pressure adjusting port is blocked from communicating the air duct to the outer side when the air duct is in a negative pressure state for sucking the pet hair, so as to adjust an air pressure in the air duct.

According to an embodiment of the present invention, the grooming assembly comprises an installation base and a plurality of grooming needles, wherein the installation base is installed to the installation shell body, each of the grooming needles comprises a front end portion and a rear end portion installed on the installation base, wherein the hair scraping assembly comprises a hair scraping element, wherein the pet hair comb further comprises an operational driving assembly which is operatively connected to the hair scraping element, wherein the hair scraping element is arranged to be switched between a first state and a second state, wherein when the hair scraping element is in the first state, the hair scraping element is in an initial position behind the front end portions of the grooming needles, wherein when the hair scraping element is in the second state, the hair scraping element is driven to move to a position corresponding to the front end portions of the grooming needles, wherein when the hair scraping element is in the first state, the air pressure adjusting port is in the unblocked state and is communicated to the air duct, wherein when the hair scraping element is in the second state, the air pressure adjusting port is in the blocked state and is not communicated to the air duct.

According to an embodiment of the present invention, the pet hair comb further comprises a covering element having a mating port, wherein the operational driving assembly is operatively connected to the covering element to allow the covering element to be switched between the blocked state in which the covering element covers the air pressure adjusting port to block the air pressure adjusting port from communicating with the air duct and the unblocked state in which the mating port is communicated to the air pressure adjusting port for communicating the air pressure adjusting port to the air duct.

According to an embodiment of the present invention, the operational driving assembly comprises an operation element, and the covering element comprises a covering plate which is operatively connected to the operation element, and when the operation element is driven to move, the covering plate is driven to move, so as to switch the air pressure adjusting port between the blocked state and the unblocked state.

According to an embodiment of the present invention, the covering plate is integrally and operatively connected to the operation element.

According to an embodiment of the present invention, the operation element is one of a pressing element and a pushing element.

According to an embodiment of the present invention, the installation shell body comprises an installation head and a gripping part connected to the installation head, wherein the operation element is operatively installed on the installation head.

According to an embodiment of the present invention, the installation shell body comprises an installation head and a gripping part connected to the installation head, wherein the operation element is installed on the gripping part.

According to an embodiment of the present invention, the operational driving assembly further comprises a movement transmission element operatively connected between the operation element and the hair scraping element, and when the operation element is driven to move, the operation element drives the hair scraping element to move, thereby switching the hair scraping element between the first state and the second state.

According to an embodiment of the present invention, the movement transmission element comprises a driving column, wherein the hair scraping assembly further comprises an engaging element connected to the hair scraping element, and the engaging element comprises a hollow column body which is connected to the driving column, wherein the hollow column body is connected to the hair scraping element, wherein the hollow column body has an inward extension wall, wherein the driving column is inserted into the hollow column body and abuts against the inward extension wall.

According to an embodiment of the present invention, the movement transmission element further comprises an elastic reset element disposed between the installation shell body and the operation element for restoring the operation element.

According to an embodiment of the present invention, the hair scraping assembly comprises an extension sleeve operatively connected to the hair scraping element to function as the covering element, wherein when the hair scraping element is driven to move, the extension sleeve is driven to move, so as to switch the air pressure adjusting port between the blocked state and the unblocked state.

According to an embodiment of the present invention, the extension sleeve is integrally extended from the hair scraping element.

According to an embodiment of the present invention, the pet hair comb further comprises an operational driving assembly for driving the relative movement between the hair scraping assembly and the grooming assembly, wherein the said operational driving assembly comprises an operation element, and the air pressure adjusting port is provided in the operation element.

According to an embodiment of the present invention, the pet hair comb further comprises a covering element, the operational driving assembly is operatively connected to the covering element to allow the covering element to be switched between the blocked state in which the covering element covers the air pressure adjusting port to block the air pressure adjusting port from communicating with the air duct and the unblocked state in which the covering element is spaced apart from the air pressure adjusting port for allowing the air pressure adjusting port to be communicated with the said air duct.

According to an embodiment of the present invention, the covering element is located on an outside or inner side of the air pressure adjusting port.

According to an embodiment of the present invention, the hair scraping element is located on a front side of the installation base, and the hair scraping element has a plurality of needle holes corresponding to the plurality of grooming needles allowing the grooming needles to pass therethrough respectively.

According to an embodiment of the present invention, the installation shell body comprises an installation head and a gripping part connected to the installation head, wherein the installation head has a head cavity, and the gripping part has a hollow cavity in communication with the head cavity, wherein the installation base is installed on the installation head and has a through hole, wherein the pet hair comb further comprises an extension sleeve extended rearward from the hair scraping element, wherein the extension sleeve passes through the through hole of the installation base and extended into the head cavity.

According to an embodiment of the present invention, the installation base has a through hole, and the hair scraping element is arranged at a position corresponding to the through hole of the installation base, wherein when the hair scraping element is in the second state, the hair scraping element is extended out of the through hole of the installation base.

According an another aspect of the present invention, the present invention provides a hair removing method by a pet hair comb, comprising the following steps.
(a) Maintain a negative pressure state in an air duct of the pet hair comb.
(b) Switch an air pressure adjusting port between an unblocked sate in which said air pressure adjusting port communicates said air duct to an outer side and a blocked state in which said air pressure adjusting port is blocked from communicating said air duct to the outer side, so as to adjust an air pressure in the air duct.

According to an embodiment of the present invention, during the relative movement between the hair scraping assembly and the grooming assembly, the air pressure adjusting port is gradually switched between the blocked state and the unblocked state.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a pet hair comb according to an embodiment of the present invention.

FIG. 2 is another perspective view of the pet hair comb according to above embodiment of the present invention.

FIG. 3 is an exploded view of the pet hair comb according to the above embodiment of the present invention.

FIG. 4 is a partial perspective view of the pet hair comb according to the above embodiment of the present invention.

FIG. 5 are schematic views illustrating an operation of a hair moving assembly of the pet hair comb according to the above embodiment of the present invention.

FIG. 6 are schematic views illustrating the operation of the hair moving assembly of the pet hair comb according to a first alternative mode of the above embodiment of the present invention.

FIG. 7 are schematic views illustrating the operation of the hair moving assembly of the pet hair comb according to a second alternative mode of the above embodiment of the present invention.

FIG. 8A is a perspective view of a pet hair comb according to a third alternative mode of the above embodiment of the present invention.

FIG. 8B is a perspective view illustrating an operation state of the pet hair comb shown in FIG. 8A according to the above third alternative mode of the above embodiment of the present invention.

FIG. 9A is a perspective view of a pet hair comb according to a fourth alternative mode of the above embodiment of the present invention.

FIG. 9B is a perspective view illustrating an operation state of the pet hair comb shown in FIG. 8A according to the above fourth alternative mode of the above embodiment of the present invention.

FIG. 10 are schematic views illustrating the operation of the hair moving assembly of the pet hair comb according to a fifth alternative mode of the above embodiment of the present invention.

FIG. 11A is a perspective view of a pet hair comb according to a sixth alternative mode of the above embodiment of the present invention.

FIG. 11B is a perspective view illustrating an operation state of the pet hair comb shown in FIG. 8A according to the above sixth alternative mode of the above embodiment of the present invention.

FIG. 12 is an exploded view of the pet hair comb according to the above sixth alternative mode of the above embodiment of the present invention.

FIG. 13 is a perspective view illustrating the pet hair comb being connected to a vacuum suction device for hair removal according to the above embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

Those skilled in the art should understand that, in the disclosure of the present invention, terminologies of “longitudinal,” “lateral,” “upper,” “front,” “back,” “left,” “right,” “perpendicular,” “horizontal,” “top,” “bottom,” “inner,” “outer,” and etc. that indicate relations of directions or positions are based on the relations of directions or positions shown in the appended drawings, which are only to facilitate descriptions of the present invention and to simplify the descriptions, rather than to indicate or imply that the referred device or element is limited to the specific direction or to be operated or configured in the specific direction. Therefore, the above-mentioned terminologies shall not be interpreted as confine to the present invention.

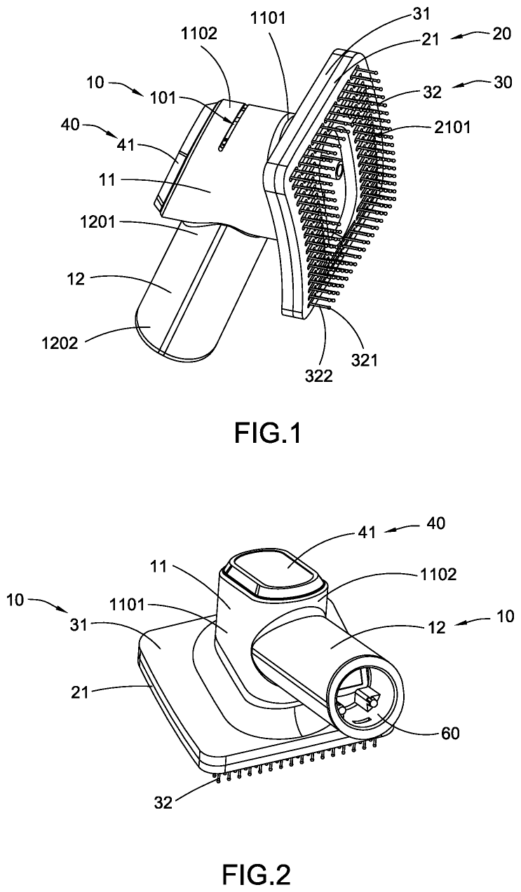

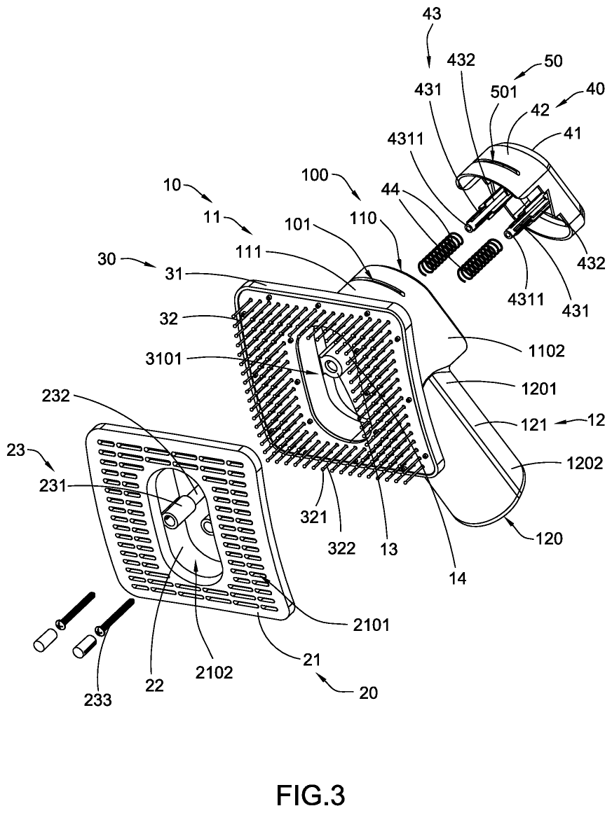

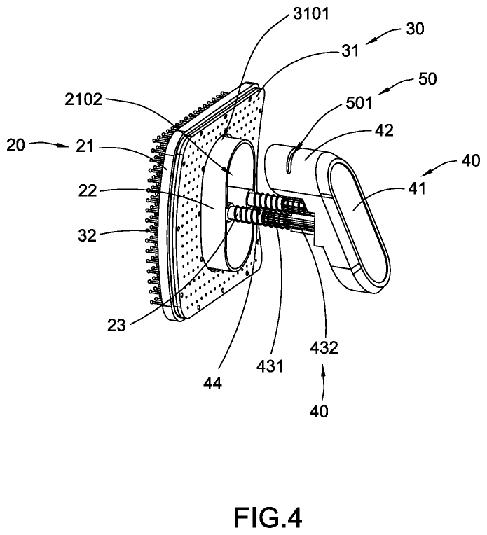

Referring to FIGS. 1 to 13 of the drawings, a pet hair comb according to an embodiment of the present invention is elucidated. This invention provides a loose hair removal solution, and accordingly, the structure of the loose hair removal device is designed. In this embodiment of the present invention, an air pressure adjusting port 101 is provided for the pet hair comb, so that during the use of the pet hair comb which is connected to a vacuum suction device or integrated with an integral vacuum suction component, the air pressure adjusting port 101 is switched between a blocked state and an unblocked state, causing the internal air pressure of the pet hair comb to change repeatedly, thereby adjusting a pulling force on the loose hair and repeatedly changing a direction of the pulling force on the loose hair, which is beneficial for pulling the loose hair away from the pet hair comb and improving the loose hair removal rate and efficiency.

It is worth mentioning that in the present invention, the solution of improving the loose hair removal rate and efficiency by setting the air pressure adjusting port 101 can be applied to various combs and other products that need to remove loose hair. For the purpose of explanation and illustration, the present invention uses a pet hair comb used for pet grooming as an example to illustrate the structure of the loose hair removal device in the present invention.

Specifically, the pet hair comb comprises an installation shell body 10, a hair scraping assembly 20, a grooming assembly 30, and an operational driving assembly 40. The installation shell body 10 has an air duct 100. More specifically, the installation shell body 10 comprises an installation head 11 and a gripping part 12 which is connected to the installation head 11. The installation head 11 comprises a head shell body 111 defining a head cavity 110. The gripping part 12 comprises a gripping part shell body 121 having a hollow cavity 120. The head cavity 110 and the hollow cavity 120 are communicated to each other to form the air duct 100.

The head shell body 111 and the gripping part shell body 121 can be integrally formed or be assembled, and this is not limited to the present invention.

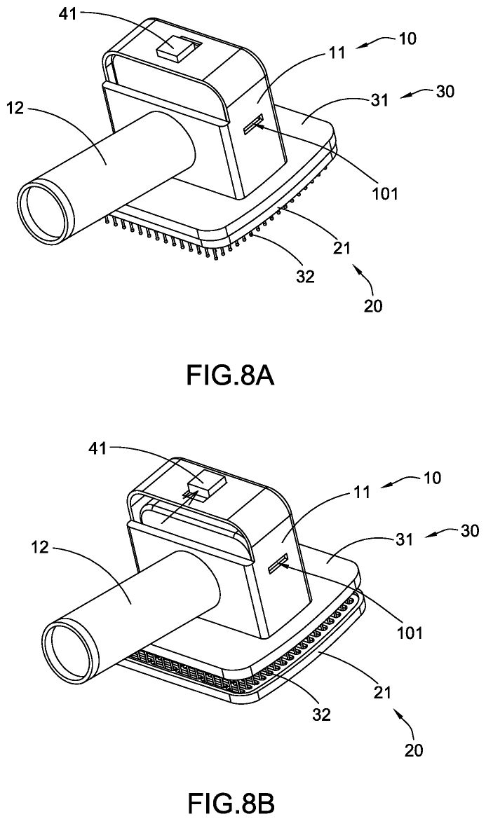

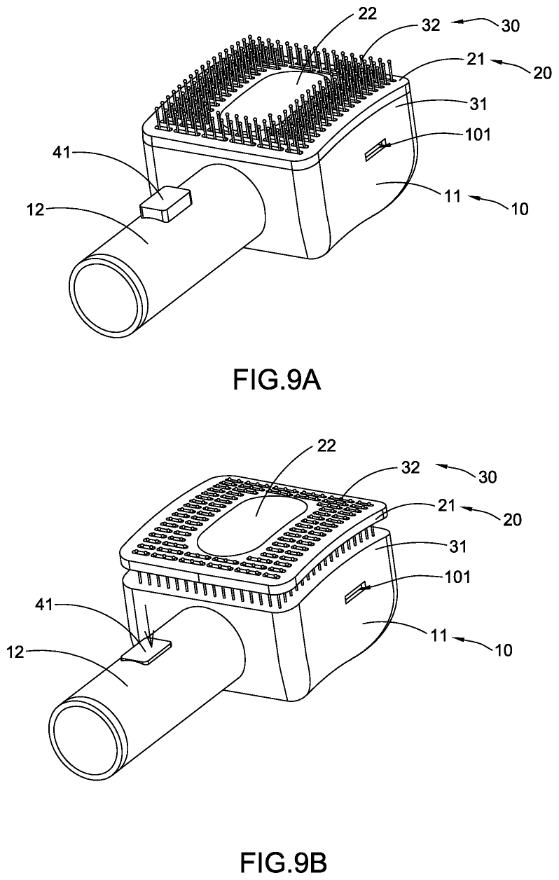

The shape and arrangement of the head shell body 111 and the gripping part shell body 121 are not limited to the present invention. For example, the head shell body 111 comprises a head first end portion 1101 and a head second end portion 1102, and the head first end portion 1101 is located at a front side of the head second end portion 1102. The gripping part shell body 121 has a first end portion 1201 and a second end portion 1202. In some embodiments of the present invention, the head shell body 111 is elliptical and tubular, and the gripping part shell body 121 is cylindrical, as shown in FIGS. 1 to 7. In other embodiments of the present invention, the head shell body 111 is rectangular and tubular, and the gripping part shell body 121 is cylindrical, as shown in FIGS. 8A to 9B. In yet other embodiments of the present invention, the head shell body 111 is cylindrical and curvedly extended in the axial direction, and the gripping part shell body 121 is cylindrical.

In some embodiments of the present invention, the head shell body 111 and the gripping part shell body 121 are arranged in a “T” configuration. The gripping part shell body 121 is extended from a middle of the head shell body 111 which is the portion between the head first end portion 1101 and the head second end portion 1102. In other embodiments of the present invention, the gripping part shell body 121 can be extended from the second end portion of the head shell body 111.

The grooming assembly 30 comprises an installation base 31 and a plurality of grooming needles 32. The installation base 31 is installed at the head first end portion 1101 of the installation head 11 of the installation shell body 10. The installation base 31 has a through hole 3101 which is communicated to the air duct 100. The plurality of grooming needles 32 are arranged on the installation base 31. The grooming needles 32 can be configured into various structures, such as combing needles, scraping needles, or trimming needles. For example, in this embodiment, each grooming needle 32 comprises a front end portion 321 and a rear end portion 322 connected to the front end portion 321. The rear end portion 322 of each grooming needle 32 is installed on the installation base 31, and the front end portion 321 of the grooming needle 32 is a free end portion and can be implemented as a spherical shape to reduce damage to the pet hair. The rear end portion 322 is a needle body, which can be rod-shaped, plate-shaped, etc. During the process of combing the pet hair, the pet's hair is inserted from the front end portions 321 of the grooming needles 32 into the gaps between the rear end portions 322 of the grooming needles 32.

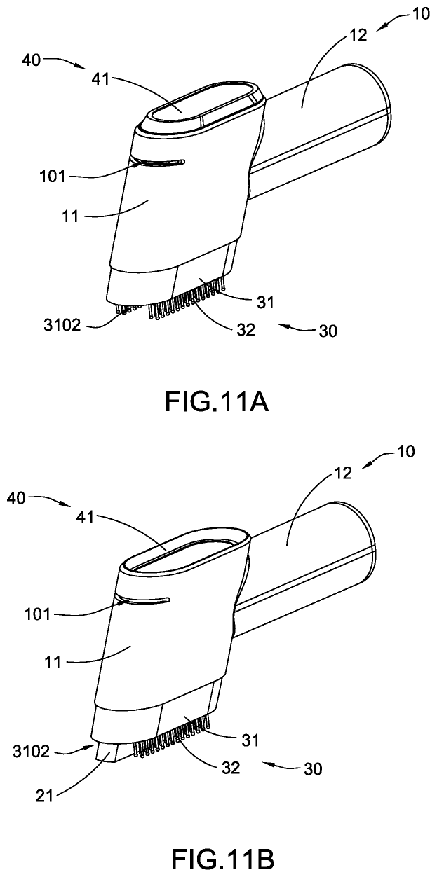

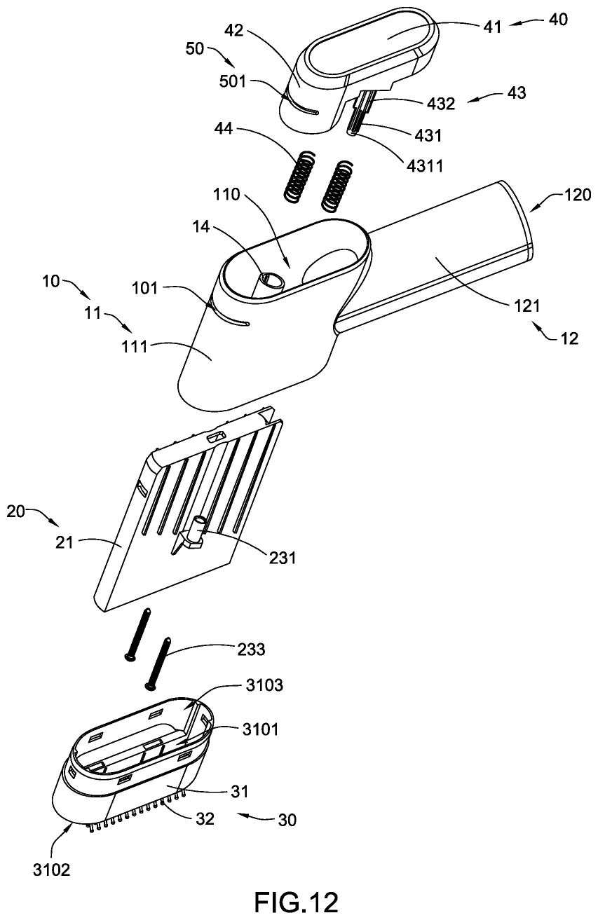

The shape and installation method of the installation base 31 are not limited to the present invention. In some embodiments of the present invention, the installation base 31 is rectangular and in a plate shape, as shown in FIGS. 1 to 9B. In other words, the installation base 31 is implemented as a comb needle installation board. In other embodiments of the present invention, the installation base 31 is elliptical and cylindrical, as shown in FIGS. 11A to 12. In other words, the installation base 31 can be implemented as a comb needle installation cylinder.

In some embodiments of the present invention, the installation base 31 is integrally connected to the installation shell body 10, as shown in FIGS. 1 to 9B. In other embodiments of the present invention, the installation base 31 is assembled and connected to the installation shell body 10, as shown in FIGS. 11A to 12. The installation base 31 can be fitted onto the installation shell body 10 or installed on the installation shell body 10 in other ways.

The structure and installation method of the hair scraping assembly 20 are not limited to the present invention. In some embodiments of the application, the hair scraping assembly 20 comprises a hair scraping element 21 and an extension sleeve 22. The installation base 31 comprises a relative front end surface and a rear end surface. The hair scraping element 21 is located on the front side of the installation base 31, as shown in FIGS. 1 to 9B, and is implemented as a hair removing and scraping plate. The hair scraping element 21 is substantially parallel to the front end surface of the installation base 31. The hair scraping element 21 has a plurality of needle holes 2101 and a central ventilation hole 2102, wherein the central ventilation hole 2102 is communicated to the air duct 100. The needle holes 2101 are respectively correspond to the grooming needles 32, and the grooming needles 32 passes through the needle holes 2101 respectively. The hair scraping element 21 is capable of moving forward and backward along the extending direction of the grooming needles 32. Due to the fact that the grooming needles 32 are penetrating through the corresponding needle holes 2101 of the hair scraping element 21, when the hair scraping element 21 moves forward, the hair scraping element 21 will push the hair accumulated at the rear end portions 322 of the grooming needles 32 to move forward, so that the hair can be pushed away from the grooming needles 32. The extension sleeve 22, which is extended rearward from the hair scraping element 21 and passes through the through hole 3101 of the installation base 31, is extended into the head cavity 110.

In another embodiment of the present invention, the hair scraping assembly 20 comprises a hair scraping element 21 with a hollow structure, the hair scraping element 21 is arranged at a position corresponding to the through hole 3101 of the installation base 31 located in the head cavity 110, as shown in FIG. 12. The hair scraping element 21 is capable of moving back and forth in the through hole 3101 of the installation base 31. When the hair scraping element 21 moves forward, the hair scraping element 21 passes through along an inner side of the grooming needles 32, pushes the hair accumulated at the rear end portions 322 of the grooming needles 32 to move forward until the hair is pushed away from the grooming needles 32.

The operational driving assembly 40 is operatively connected to the hair scraping element 21, allowing the hair scraping element 21 to switch between a first state and a second state. When the hair scraping element 21 is in the first state, the hair scraping element 21 is in the initial position, behind the front end portions 321 of the grooming needles 32.

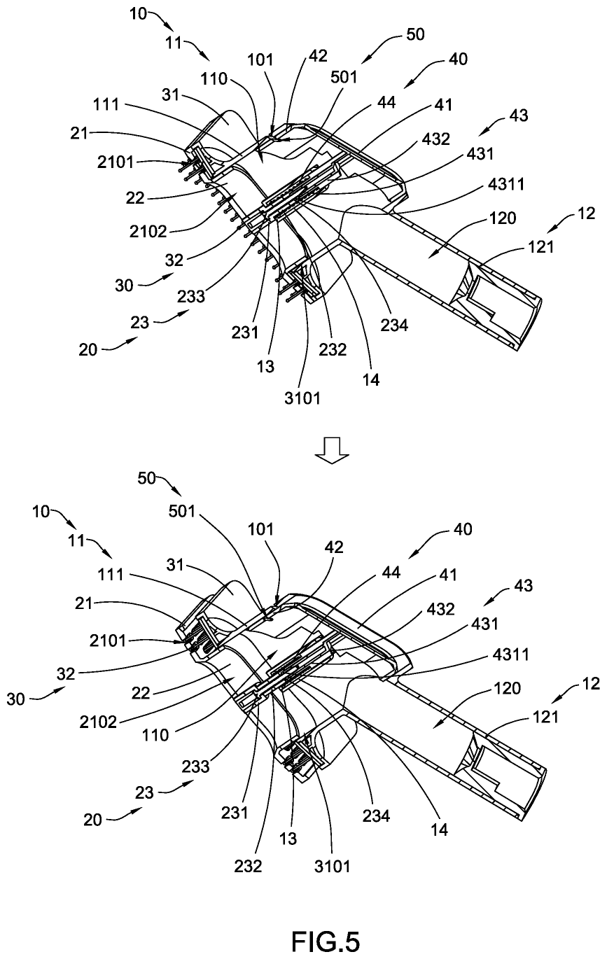

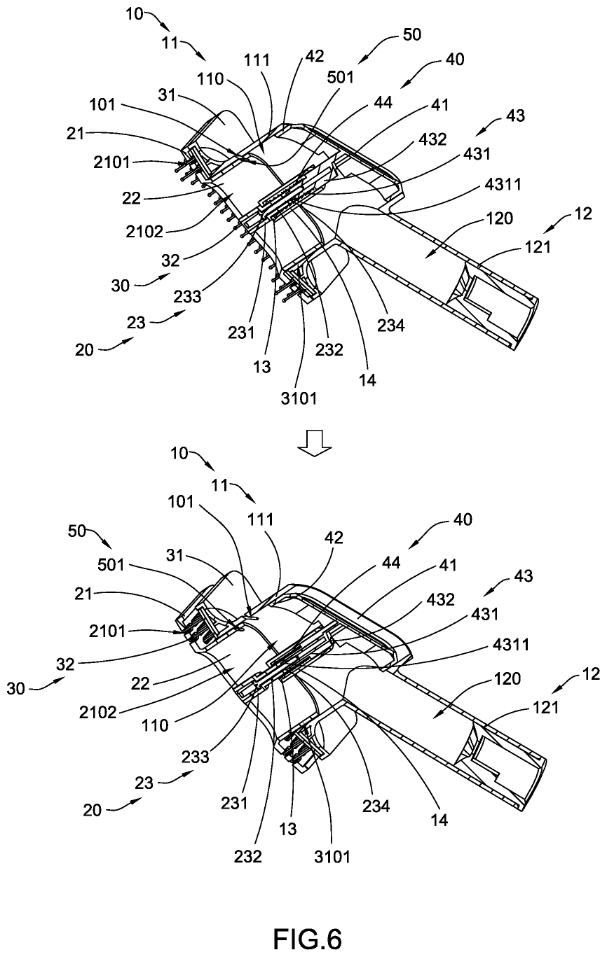

For example, in one embodiment of the present invention, the hair scraping element 21 is located on the front side of the installation base 31. As shown in FIGS. 5 and 6, when the hair scraping element 21 is in the first state, it is located at the rear end portions 322 of the grooming needles 32 and is almost in contact with the installation base 31, or maintains a small gap with the installation base 31. That is, the initial position of the hair scraping element 21 is located on the front side of the installation base 31 and adjacent to the installation base 31.

In another embodiment of the present invention, the hair scraping element 21 is arranged at a position corresponding to the through hole 3101 of the installation base 31, and the through hole 3101 of the installation base 31 has a front opening 3102 and a back opening 3103. As shown in FIGS. 11A and 11B, when the hair scraping element 21 is in the first state, it does not extend beyond the front opening 3102 of the through hole 3101 of the installation base 31. That is, the initial position of the hair scraping element 21 is located behind the front opening 3102 of the through hole 3101 of the installation base 31.

When the hair scraping element 21 is in the second state, the hair scraping element 21 is driven to the front end portions 321 of the grooming needles 32. For example, in one embodiment of the present invention, during the process of switching the hair scraping element 21 from the first state to the second state, the hair scraping element 21 moves from the rear end portions 322 of the grooming needles 32 to the front end portions 321 of the grooming needles 32. In another embodiment of the present invention, during the process of switching the hair scraping element 21 from the first state to the second state, the hair scraping element 21 is moved from the rear side of the front opening 3102 of the through hole 3101 of the installation base 31 to the front end portions 321 of the grooming needles 32

In another embodiment, the relative movement between the grooming assembly 30 and the hair scraping assembly 20 can also be achieved by fixing the hair scraping assembly 20 and moving the grooming assembly 30. That is, when the grooming needles 32 of the grooming assembly 30 are protruding from the hair scraping element 21 of the hair scraping assembly 20, the grooming needles 32 can be used to comb and remove loose hair from the pet. When the grooming assembly 30 moves back, the front end portions 321 of the grooming needles 31 reaches the position of the hair scraping element 21, so that the hair scraping element 21 can push and scrape the pet hair on the grooming needles 32.

The operational driving assembly 40 comprises an operation element 41 and a movement transmission element 43 which is operatively coupled between the operation element 41 and the hair scraping element 21. The operation element 41 can be moved under user operation, thereby driving the hair scraping element 21 to move through the movement transmission element 43, so that the hair scraping element 21 can be switched between the first state and the second state.

The operation element 41 is operationally installed on the installation shell body 10. The operation element 41 can be installed on the installation head 11, as shown in FIGS. 1 to 8B. The operation element 41 can also be operationally installed at other positions, for example, the operation element 41 can be installed on the gripping part 12, as shown in FIGS. 9A and 9B.

The operation mode of the operation element 41 is not limited to the present invention. For example, the operation element 41 is implemented as a pressing element; as shown in FIGS. 5 to 7, the pressing element is implemented as a pressing plate; as shown in FIGS. 9A to 9B, the pressing element is implemented as a pressing block. When the operation element 41, which is implemented as a pressing element, is pressed, the operation element 41 drives the hair scraping element 21 which is implemented as a pushing plate to move forward; when the operation element 41, which is implemented as the pressing element, is released, the restoring of the operation element 41 will drive the hair scraping element 21 which is implemented as the pushing plate to move backward. Another example is that the operation element 41 is implemented as a pushing element, as shown in FIGS. 8A and 8B, the pushing element is implemented as a pushing block. When the operation element 41 implemented as the pushing element is pushed in a first direction, the operation element 41 will drive the hair scraping element 21 implemented as a pushing plate to move forward; when the operation element 41 implemented as the pushing element is pushed in a second direction, the operation element 41 will drive the hair scraping element 21 implemented as a pushing plate to move backward, where the first direction and the second direction are different, for example, the first direction and the second direction are opposite directions. Another example is that the operation element 41 is implemented as a pulling element. When the operation element 41 embodied as the pulling element is pushed in a third direction, the operation element 41 will drive the pushing plate to move forward; when the operation element 41 implemented as the pulling element is pulled in a fourth direction, the operation element 41 will drive the hair scraping element 21 embodied as the pushing plate to move backward, and the third direction and the fourth direction are opposite directions.

The specific embodiment of the operation element 41 being operatively connected to the hair scraping element 21 is not limited to the present invention. In one example of the present invention, the movement transmission element 43 comprises a driving column 431 and a protrusion 432 protruded from an outer peripheral wall of the driving column 431. The hair scraping assembly 20 further comprises an engaging element 23 which is connected to the hair scraping element 21. The engaging element 23 comprises a hollow column body 231 and a screw 233. The hollow column body 231 is connected to the hair scraping element 21, and the screw 233 passes through the hollow column body 231 from the front side of the hollow column body 231. The hollow column body 231 has a rear inner peripheral wall 234 and an inward extension wall 232. The driving column 431 is inserted into the hollow column body 231 from a rear side of the hollow column body 231, and a front end 4311 of the driving column 431 abuts against the inward extension wall 232. The screw 233 is inserted into the driving column 431, and the hollow column body 231 is fitted outside the driving column 431 and abuts against the protrusion 432.

The hollow column body 231 can be directly connected to the hair scraping element 21 or indirectly connected to the hair scraping element 21. For example, in one embodiment of the present invention, the hollow column body 231 is connected to the hair scraping element 21 through the extension sleeve 22. Specifically, as shown in FIG. 5, the extension sleeve 22 is extended rearward from the hair scraping element 21 and passes through the through hole 3101 of the installation base 31, so as to be extended into the head cavity 110. The hollow column body 231 is installed on an inner side of the extension sleeve 22, so as to be connected the hollow column body 231 to the hair scraping element 21. In another embodiment of the present invention, the hollow column body 231 is directly installed on an outer side of the hair scraping element 21, as shown in FIG. 12.

In some embodiments of the present invention, the movement transmission element 43 further comprises an elastic reset element 44. The elastic reset element 44 is set between the installation shell body 10 and the operation element 41, so that the operation element 41 can be operated and moved back to its initial position automatically after being released. For example, the operation element 41 is implemented as a pressing element, and when the user releases the pressing element, the pressable plate automatically rebounds because of the restoring effect of the elastic reset element 44.

In one embodiment of the present invention, the installation shell body 10 comprises a locking wall 13 and a rear extending sleeve 14. The locking wall 13 is extended inward from an inner wall of the shell body and is located on a front side of a front end of the elastic reset element 44. The rear extending sleeve 14 is extended backward from the locking wall 13 and is fitted outside the elastic reset element 44. The elastic reset element 44 is implemented as a spring and is fitted outside the hollow column body 231 and the driving column 431. One end of the elastic reset element 44 is biasing against the locking wall 13, and the other end is biasing against the protrusion 432 of the movement transmission element 43.

It should be understood that the elastic reset element 44 can be implemented in other structures and can also be set between the installation shell body 10 and the operation element 41 in other ways. For example, one end of the elastic reset element 44 can be fixed to the installation shell body 10, and the other end can be fixed to the operation element 41.

As mentioned above, in this embodiment of the present invention, an air pressure adjusting port 101 is provided for the pet hair combing device for removing loose hair, so that during the use of the pet hair combing device, the air pressure adjusting port 101 is switched between a blocked state and an unblocked state, so as to cause the internal air pressure of the pet hair combing device to change repeatedly, thereby adjusting the pulling force on the loose hair from loose to tight and repeatedly changing the direction of the pulling force on the loose hair, so that it is beneficial for pulling the loose hair away from the pet hair combing device and improving the loose hair removal rate and efficiency.

Correspondingly, the pet hair comb is formed with the air pressure adjusting port 101, and when the hair scraping element 21 is in the first state, the air pressure adjusting port 101 is in the unblocked state; when the hair scraping element 21 is in the second state, the air pressure adjusting port 101 is in the blocked state. During the use of the pet hair comb, the pet hair comb can be connected to a suction device, and the interior of the pet hair comb is in a negative pressure state. When the air pressure adjusting port 101 is in the unblocked state, the air pressure adjusting port 101 allows the internal of the pet hair comb to communicate with the external air, the internal air pressure of the pet hair comb increases, and the negative pressure decreases, resulting in a smaller pulling force on the loose hair; when the air pressure adjusting port 101 is moved to the blocked state, the air intake at the air pressure adjusting port 101 decreases, the internal air pressure of the pet hair comb relatively decreases, the negative pressure increases, resulting in an increase in the pulling force on the loose hair.

It is worth mentioning that the positioning of the air pressure adjusting port 101 and the switching method of the state of the air pressure adjusting port 101 are not limited to the present invention. For example, the air pressure adjusting port 101 can be set at the installation head 11 of the installation shell body 10, and the state of the air pressure adjusting port 101 can be switched by driving a covering element 50. The air pressure adjusting port 101 can also be set at the gripping part 12 of the installation shell body 10, and the state of the air pressure adjusting port 101 can be switched by driving the covering element 50. The air pressure adjusting port 101 can be set on the operation element 41, and the state of the air pressure adjusting port 101 can be controlled by the operator. In addition, the state of the air pressure adjusting port 101 can also be switched by blocking it with the user's finger.

Correspondingly, in one embodiment of the present invention, the air pressure adjusting port 101 is located at the installation head 11 of the installation shell body 10. The pet hair comb also comprises the covering element 50 which has a mating port 501. The operational driving assembly 40 is operatively connected to the covering element 50, allowing the covering element 50 to be switched between the blocked state and the unblocked state of the air pressure adjusting port 101. When the covering element 50 is in the unblocked state of the air pressure adjusting port 101, the mating port 501 is aligned with the air pressure adjusting port 101, allowing the air pressure adjusting port 101 to be unblocked and communicated to the air duct 100. When the covering element 50 is in the blocked state of of the air pressure adjusting port 101, the covering element 50 blocks the air pressure adjusting port 101, so that the air pressure adjusting port 101 is not communicated to the air duct 100.

In this embodiment, the covering element 50 is implemented as a covering plate 42 which is operatively connected to the operation element 41. When the operation element 41 is driven to move, the covering plate 42 is moved accordingly, so that the air pressure adjusting port 101 can be switched between the blocked state and the unblocked state. In this embodiment, the covering plate 42 is operatively connected to the operation element 41 in an integral manner. It should be understood that the covering plate 42 can also be operatively connected to the operation element 41 in other ways, such as being directly connected to the operation element 41 by screws, fitting connection, plug-in connection, etc., or indirectly connected to the operation element 41 through a transmission member.

Specifically, the covering plate 42 is set on the inner side of the head shell body 111 and is extended forward from the operation element 41. At least a portion of the covering plate 42 is in contact with the head shell body 111 and is extended to a position near the air pressure adjusting port 101.

As shown in FIG. 5, in this embodiment, the operation element 41 is implemented as a pressing element. When the operation element 41 is not pressed, the covering plate 42 does not block the air pressure adjusting port 101, and the mating port 501 of the covering plate 42 is aligned with and communicated to the air pressure adjusting port 101, so that the air pressure adjusting port 101 is in the unblocked state. The air inside the pet hair comb is in communication with the outside air, resulting in a relatively small pulling force on the loose hair. After the operation element 41 is pressed, the operation element 41 drives the hair scraping element 21 to move forward. The mating port 501 of the covering plate 42 is misaligned with the air pressure adjusting port 101, so that the air pressure adjusting port 101 is blocked by the blocking element 50, so as to be in the blocked state. The air pressure inside the pet hair comb is small, resulting in an increased pulling force on the loose hair.

In another embodiment of the present invention, the air pressure adjusting port 101 is located at the installation head 11 of the installation shell body 10. The pet hair comb also comprises the covering element 50 which has a mating port 501. The operational driving assembly 40 is operatively connected to the covering element 50, allowing the covering element 50 to be switched between the blocked state and the unblocked state of the air pressure adjusting port 101. When the covering element 50 is in the unblocked state of the air pressure adjusting port 101, the mating port 501 corresponds to the air pressure adjusting port 101, causing the air pressure adjusting port 101 to be in an unobstructed state. When the covering element 50 is in the covering state, the covering element 50 covers the air pressure adjusting port 101.

In this embodiment, the extension sleeve 22 of the hair scraping assembly 20 is used as the covering element 50. Accordingly, the extension sleeve 22 has the mating port 501. The extension sleeve 22 is operatively connected to the operation element 41 and moves with the extension sleeve 22 when the operation element 41 is driven to move, thereby switching the air pressure adjusting port 101 between the blocked state and the unblocked state. In this embodiment, the extension sleeve 22 is operatively connected to the hair scraping element 21 in an integral manner and can be operatively connected to the hair scraping element 21 in other ways, such as directly connected to the hair scraping element 21 by screws, fitted connection, plug connection, etc., or indirectly connected to the hair scraping element 21 through a transmission component. In this embodiment, the operation element 41 is operatively connected to the hair scraping element 21 through the extension sleeve 22.

Specifically, as mentioned above, the extension sleeve 22 is extended rearward from the hair scraping element 21 and passes through the through hole 3101 of the installation base 31, so as to be extended into the head cavity 110. At least a portion of the extension sleeve 22 is in contact with the head shell body 111 and is extended to a position near the air pressure adjusting port 101.

As shown in FIG. 6, in this embodiment, the operation element 41 is implemented as a pressing element. When the operation element 41 is not pressed, the extension sleeve 22 is in a state not blocking the air pressure port 101, and the mating port 501 of the extension sleeve 22 is aligned with the air pressure adjusting port 101, so that the air pressure adjusting port 101 is in the unblocked state, and the air inside the pet hair comb is in communication with the outside air, and the negative pressure inside the pet hair comb will be relatively small, resulting in a smaller pulling force on the loose hair. After the operation element 41 is pressed, the operation element 41 drives the hair scraping element 21 to move forward, thereby driving the extension sleeve 22 to move forward, the mating port 501 of the extension sleeve 22 is moved to be staggered with the air pressure adjusting port 101, the air pressure adjusting port 101 is in the blocked state, the air pressure inside the pet hair comb is small, resulting in an increase in the pulling force on the loose hair.

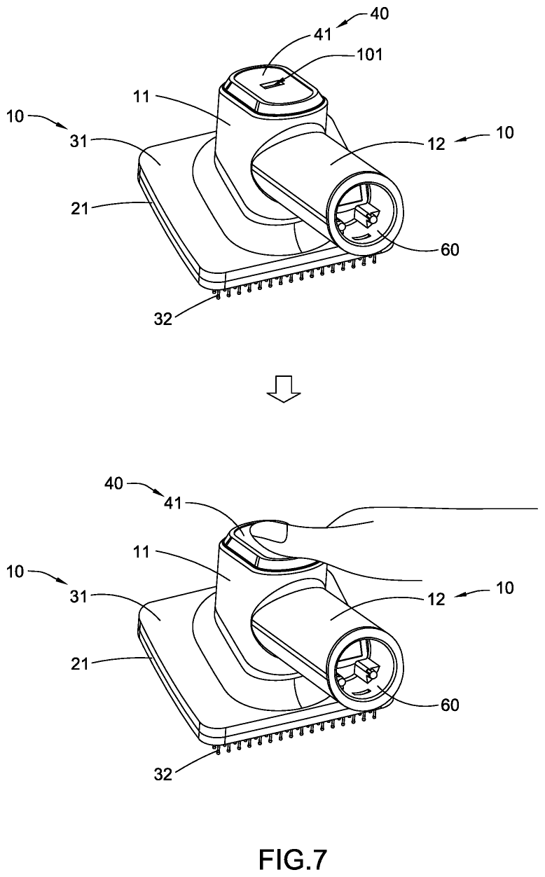

In another embodiment of the present invention, as shown in FIG. 7, the air pressure adjusting port 101 is formed in the operation element 41. The air pressure adjusting port 101 is capable of being covered or released by a finger of the user, so that the air pressure adjusting port 101 can be switched between the blocking state and the unblocked state. For example, the operation element 41 is implemented as a pressing element, and the air pressure adjusting port 101 is disposed in the surface of the pressing element. When the user presses the pressing element, the air pressure adjusting port 101 is covered, so that the air pressure adjusting port 101 is in the blocked state, the air pressure inside the pet hair comb is smaller, so as to increase the pulling force on the loose hair. When the user releases the pressing element, the air pressure adjusting port 101 is also released, so that the air pressure adjusting port 101 is in the unblocked state, the air duct 100 inside the pet hair comb is communicated to the outside, and the air pressure inside the pet hair comb is increased, resulting in a smaller pulling force on the loose hair.

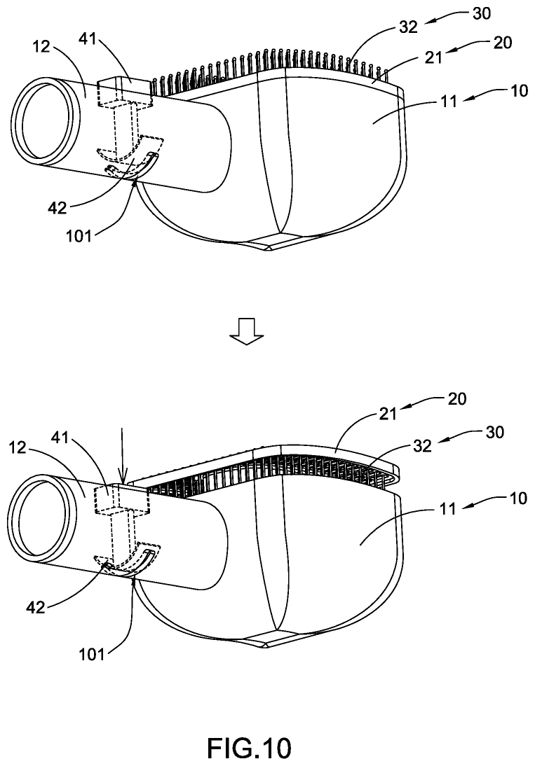

In another embodiment of the present invention, as shown in FIG. 10, the air pressure adjusting port 101 is located in the gripping part 12. The pet hair comb also comprises the covering element 50 which has a mating port 501. The operational driving assembly 40 is operatively connected to the covering element 50, allowing the covering element 50 to switch the air pressure adjusting port 101 between the blocked state and the unblocked state. When in the unblocked state, the mating port 501 is aligned and communicated with the air pressure adjusting port 101, so that the air pressure adjusting port 101 is in the unblocked state. When in the blocked state, the covering element 50 covers the air pressure adjusting port 101, so that the air pressure adjusting port 101 is not communicated to the air duct 100.

In this embodiment, the covering element 50 is implemented as the covering plate 42 which is operatively connected to the operation element 41. When the operation element 41 is driven to move, the covering plate 42 is driven to move, thereby switching the air pressure adjusting port 101 between the blocked state and the unblocked state. In this embodiment, the covering plate 42 is operatively connected to the operation element 41 through a connecting member. It should be understood that the covering plate 42 can also be operatively connected to the operation element 41 in other ways, such as directly connected to the operation element 41 through integral connection, screw connection, fitting connection, plug-in connection, etc.

Specifically, the covering plate 42 is located at an inner side of the gripping part shell body 121 and corresponds to the air pressure adjusting port 101. In this embodiment, the operation element 41 is implemented as a pressing element. When the operation element 41 is not pressed, the covering plate 42 is spaced apart from the air pressure adjusting port 101, the air pressure adjusting port 101 is in the unblocked state, the air duct 100 inside the pet hair comb is in communication with the outside, and the air pressure inside the pet hair comb is larger, resulting in a smaller pulling force on the loose hair. After the operation element 41 is pressed, the operation element 41 drives the covering plate 42 to move towards the air pressure adjusting port 101, so that the air pressure adjusting port 101 is switched to a blocked state, the air pressure of the air duct 100 inside the pet hair comb is decreased, resulting in an increased pulling force on the loose hair.

It is worth mentioning that in the above embodiment, the covering plate 42 and the hair scraping element 21 share a driving component, that is, the operation element 41. It should be understood that the covering plate 42 can also be driven by other driving components, that is, the covering plate 42 and the hair scraping element 21 are respectively driven by different driving components.

In the above embodiments, the covering element 50 is located at the inner side of the air pressure adjusting port 101, it should be understood that the covering element 50 may also be set at the outer side of the air pressure adjusting port 101 in other alternative modes.

It is also worth mentioning that during the process of using the hair scraping element 21 of the pet hair comb for separating and scraping the loose hair, the air pressure adjusting port 101 being blocked will result in a decrease in air pressure inside the air duct 100 of the pet hair comb and an increase in the pulling force on the loose hair. In this way, the state of the air pressure adjusting port 101 and the state of the hair scraping element 21 cooperate with each other. During the hair scraping process, the pulling force on the loose hair increases, while during the restoring process of the pet hair comb, the pulling force on the loose hair relatively decreases, which helps to separate the loose hair from the pet hair comb.

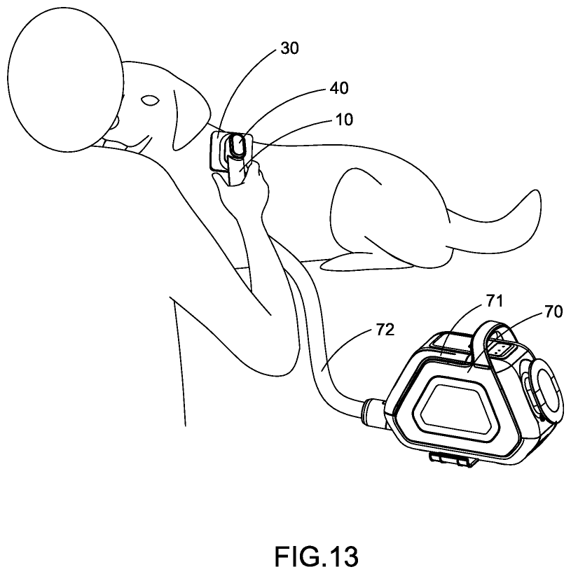

As mentioned above, as shown in FIG. 13, during the use of the pet hair comb, the pet hair comb can be connected to a vacuum suction device 70. Accordingly, in this embodiment of the present invention, the pet hair comb comprises a suction device connecting part 60 which is suitable for being connected to a connecting pipe 71 of the vacuum suction device 70, so that the air duct 100 is communicated with the device body 72 of the vacuum suction device 70 through the connecting pipe 71, thereby allowing the pet hair to be sucked into the device body 72 through the air duct 100 and the connecting pipe 71. In this embodiment of the present invention, the suction device connecting end is located at the second end portion 1202. It should be understood that the suction device connecting end can also be set at other positions. It is also understood that in another alternative embodiment, the pet hair comb can also be integrated with a vacuum suction component in the gripping part 12, so that the pet hair can be sucked into the vacuum suction component through the gripping part 12. When the vacuum suction device 70 or the vacuum suction component is in the working state, the air duct 100 is evacuated by the vacuum suction device 70 or the vacuum suction component, and is maintained with a negative pressure. When the air duct 100 is in a negative pressure state, the air pressure adjusting port 101 is switched between a connected and disconnected state with the air duct 100 to adjust the air pressure, i.e., vacuum degree, in the air duct 100, so that the pet hair that is not easily removed from the grooming needles 32 of the grooming assembly 30 or the pet hair adhered to the inner surface of the installation shell body 10 located in the air duct 100 of the pet hair comb, is easily pushed or sucked into the vacuum suction device 70 or the vacuum suction component in a changing negative pressure environment.

It can be understood that when using the grooming assembly 30 for grooming the pet hair to remove the loose hair on the pet, the vacuum suction device 70 or the vacuum suction component can be in and idle state and not actuated to work. And after a period of hair grooming by the grooming assembly 30, the vacuum suction device 70 or the vacuum suction component can be turned on to work for sucking the loose hair. Alternatively, when it is comfortable for the pet, when the pet hair comb is used for grooming the pet hair by the grooming assembly, it is also possible to simultaneously turn on the the vacuum suction device 70 or the vacuum suction component for sucking the loose hair which is scraped down by the grooming needles 32 of the grooming assembly 30 from the coat of the pet.

The present invention also proposes a hair removal method for a pet hair comb, wherein the hair removal method for the pet hair comb comprises a step of S110: switching the state of the air pressure adjusting port 101 of the pet hair comb, so that the air pressure adjusting port 101 is in the unblocked state when the hair scraping element 21 of the pet hair comb is in the first state, and the air pressure adjusting port 101 is in the blocked state when the hair scraping element 21 of the pet hair comb is in the second state, wherein when the hair scraping element 21 is in the first state, the hair scraping element 21 is in the initial position and is located behind the front end portion 321 of the grooming needles 32 of the pet hair comb, when the hair scraping element 21 is in the second state, the hair scraping element 21 is driven to be moved to a position corresponding to the front end portions 321 of the grooming needles 32 of the pet hair comb.

Specifically, the state of the air pressure adjusting port 101 can be switched by operating the operation element 41. That is, the step S110 comprises a step of switching the state of the air pressure adjusting port 101 by operating the operation element.

In some embodiments of the present invention, the pet hair comb comprises the covering element 50 which has the mating port 501. The operational driving assembly 40 is operatively connected to the covering element 50, and the operation element 41 is implemented as a pressing element. The covering element 50 is connected to the operation element 41, or connected to the hair scraping element 21. As shown in FIGS. 5 and 6, pressing the operation element 41 will cause the mating port 501 of the covering plate 42 to be misaligned with the air pressure adjusting port 101, thereby causing the air pressure adjusting port 101 to be covered; releasing the operation element 41 will cause the mating port 501 of the covering plate 42 to be aligned and communicated with the air pressure adjusting port 101, thereby causing the air pressure adjusting port 101 to communicate the air duct 100 to the outer side.

Correspondingly, in some embodiments of the present invention, the step S110 comprises a step of S111: when the operation element 41 is pressed, causing the mating port 501 of the covering plate 42 to be misaligned with the air pressure adjusting port 101, thereby causing the air pressure adjusting port 101 to be covered and blocked; and a step of S112: when the operation element 41 is released, causing the mating port 501 of the covering plate 42 to be aligned and communicated with the air pressure adjusting port 101, thereby causing the air pressure adjusting port 101 to be communicated to the air duct 100.

In some other embodiments of the present invention, the pet hair comb comprises the covering element 50 having the mating port 501, the operational driving assembly 40 is operatively connected to the covering element 50, and the operation element 41 is implemented as a pressing element. The covering element 50 is connected to the operation element 41 or to the hair scraping element 21. Pushing the operation element 41 in a first direction will cause the mating port 501 of the covering plate 42 to be misaligned with the air pressure adjusting port 101, thereby causing the air pressure adjusting port 101 to be covered and blocked; pushing the operation element 41 in a second direction will cause the mating port 501 of the covering plate 42 to be aligned and communicated with the air pressure adjusting port 101, thereby causing the air pressure adjusting port 101 to be communicated to the air duct 100.

Correspondingly, in some other embodiments of the present invention, the step S110 comprises a step S111A: in response to the operation element 41 being pushed in a first direction to misalign the mating port 501 of the covering plate 42 with the air pressure adjusting port 101, causing the air pressure adjusting port 101 to be blocked; and a step S112A: in response to the operation element 41 being pushed in a second direction, causing the mating port 501 of the covering plate 42 to be aligned and communicated with the air pressure adjusting port 101, thereby causing the air pressure adjusting port 101 to be communicated to the air duct 100.

In some embodiments of the present invention, the air pressure adjusting port 101 is formed in the operation element 41. The air pressure adjusting port 101 is capable of being covered or released by the finger of the user, so that the air pressure adjusting port 101 can be switch between the blocked state and the unblocked state. The operation element 41 is implemented as a pressing element. As shown in FIG. 7, the air pressure adjusting port 101 is in the blocked state when the area of the operation element 41 that having the air pressure adjusting port 101 is pressed; and the air pressure adjusting port 101 is exposed when the operation element 41 is released, so as to switch the air pressure adjusting port 101 into the unblocked state.

Correspondingly, in some embodiments of the present invention, the step S110 comprises a step S111B: when the area of the air pressure adjusting port 101 in the operation element 41 is being pressed, switching the air pressure adjusting port 101 into the blocked state; and a step S112B: when the operation element 41 and the air pressure adjusting port 101 formed in the operation element 41 are simultaneously released, switching the air pressure adjusting port 101 into the unblocked state.

In some embodiments of the present invention, the air pressure adjusting port 101 is formed in the operation element 41. The air pressure adjusting port 101 is capable of being covered or released by the finger of the user, so that the air pressure adjusting port 101 can be switch between the blocked state and the unblocked state. The operation element 41 is implemented as a movable element. When push the operation element 41 in a first direction, simultaneously cover the air pressure adjusting port 101 formed in the operation element 41 by the finger of the user, the air pressure adjusting port 101 is switched into the blocked state. When push the operation element 41 in a second direction, and at the same time, the air pressure adjusting port 101 formed in the operation element 41 is released, the air pressure adjusting port 101 will be in the unblocked state.

Correspondingly, in some embodiments of the present invention, the step S110 comprises a step S11 IC: when the operation element 41 is pushed in the first direction, and the air pressure adjusting port 101 in the operation element 41 is covered, switching the air pressure adjusting port 101 into the blocked state; and a step S112C: when the operation element 41 is pushed in the second direction, and the air pressure adjusting port 101 in the operation element 41 is released, switching the air pressure adjusting port 101 into the blocked state.

In some embodiments of the present invention, the pet hair comb comprises the covering element 50, and the operational driving assembly 40 is operatively connected to the covering element 50. The operation element 41 is implemented as a pressing element. The covering element 50 is connected to the operation element 41, or connected to the hair scraping element 21. Pressing the operation element 41 will cause the covering plate 42 to cover the air pressure adjusting port 101, thereby switching the air pressure adjusting port 101 into the blocked state; releasing the operation element 41 will cause the covering plate 42 to move away from the air pressure adjusting port 101, thereby switching the air pressure adjusting port 101 into the unblocked state.

Correspondingly, in some embodiments of the present invention, the step S110 comprises a step S111D: when the operation element 41 is pressed to cover the air pressure adjusting port 101 with the covering plate 42, switching the air pressure adjusting port 101 into the blocked state; and a step S112D: when the operation element 41 is released to move the covering plate 42 away from the air pressure adjusting port 101, switching the air pressure adjusting port 101 into the unblocked state.

In some embodiments of the present invention, the pet hair comb comprises the covering element 50, and the operational driving assembly 40 is operatively connected to the covering element 50. The operation element 41 is implemented as a pushing element. The covering element 50 is connected to the operation element 41 or to the hair scraping element 21. By pushing the operation element 41 in a first direction, the covering plate 42 covers the air pressure adjusting port 101, thereby allowing the air pressure adjusting port 101 to be in the blocked state. By pushing the operation element 41 in a second direction, the covering plate 42 is disengaged from the air pressure adjusting port 101, thereby allowing the air pressure adjusting port 101 to be in the unblocked state.

Correspondingly, in some embodiments of the present invention, the step S110 comprises a step S111E: in response to the operation element 41 being pushed in a first direction to cover the air pressure adjusting port 101 with the covering plate 42, allowing the air pressure adjusting port 101 to be in the blocked state; and a step S112E: in response to the operation element 41 being pushed in a second direction to disengage the covering plate 42 from the air pressure adjusting port 101, allowing the air pressure adjusting port 101 to be in the unblocked state.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and are subject to change without departure from such principles. Therefore, this invention includes all modifications encompassed within the spirit and scope of the following claims.

What is claimed is:

1. A pet hair comb, comprising:
an installation shell body having an air duct;
a grooming assembly installed on said installation shell body; and
a hair scraping assembly, wherein a relative movement between said hair scraping assembly and said grooming assembly allows said hair scraping assembly to scrape down the pet hair on said grooming assembly;
wherein the pet hair comb has an air pressure adjusting port which is configured to be switched between an unblocked sate in which said air pressure adjusting port communicates said air duct to an outer side and a blocked state in which said air pressure adjusting port is blocked from communicating said air duct to the outer side when said air duct is in a negative pressure state for sucking the pet hair, so as to adjust an air pressure in said air duct.

2. The pet hair comb according to claim 1, wherein said grooming assembly comprises an installation base and a plurality of grooming needles, wherein said installation base is installed to said installation shell body, each of said grooming needles comprises a front end portion and a rear end portion installed on said installation base, wherein said hair scraping assembly comprises a hair scraping element, wherein said pet hair comb further comprises an operational driving assembly which is operatively connected to said hair scraping element, wherein said hair scraping element is arranged to be switched between a first state and a second state, wherein when said hair scraping element is in said first state, said hair scraping element is in an initial position behind said front end portions of said grooming needles, wherein when said hair scraping element is in said second state, said hair scraping element is driven to move to a position corresponding to said front end portions of said grooming needles, wherein when said hair scraping element is in said first state, said air pressure adjusting port is in said unblocked state and is communicated to said air duct, wherein when said hair scraping element is in said second state, said air pressure adjusting port is in said blocked state and is not communicated to said air duct.

3. The pet hair comb according to claim 2, wherein said pet hair comb further comprises a covering element having a mating port, wherein said operational driving assembly is operatively connected to said covering element to allow said covering element to be switched between said blocked state in which said covering element covers said air pressure adjusting port to block said air pressure adjusting port from communicating with said air duct and said unblocked state in which said mating port is communicated to said air pressure adjusting port for communicating said air pressure adjusting port to said air duct.

4. The pet hair comb according to claim 2, wherein said operational driving assembly comprises an operation element, and said covering element comprises a covering plate which is operatively connected to said operation element, and when said operation element is driven to move, said covering plate is driven to move, so as to switch said air pressure adjusting port between said blocked state and said unblocked state.

5. The pet hair comb according to claim 4, wherein said covering plate is integrally and operatively connected to said operation element.

6. The pet hair comb according to claim 4, wherein said operation element is one of a pressing element and a pushing element.

7. The pet hair comb according to claim 4, wherein said installation shell body comprises an installation head and a gripping part connected to said installation head, wherein said operation element is operatively installed on said installation head.

8. The pet hair comb according to claim 4, wherein said installation shell body comprises an installation head and a gripping part connected to said installation head, wherein said operation element is installed on said gripping part.

9. The pet hair comb according to claim 4, wherein said operational driving assembly further comprises a movement transmission element operatively connected between said operation element and said hair scraping element, and when said operation element is driven to move, said operation element drives said hair scraping element to move, thereby switching said hair scraping element between said first state and said second state.

10. The pet hair comb according to claim 4, wherein said movement transmission element comprises a driving column, wherein said hair scraping assembly further comprises an engaging element connected to said hair scraping element, and said engaging element comprises a hollow column body which is connected to said driving column, wherein said hollow column body is connected to said hair scraping element, wherein said hollow column body has an inward extension wall, wherein said driving column is inserted into said hollow column body and abuts against said inward extension wall.

11. The pet hair comb according to claim 9, wherein said movement transmission element further comprises an elastic reset element disposed between said installation shell body and said operation element for restoring said operation element.

12. The pet hair comb according to claim 3, wherein said hair scraping assembly comprises an extension sleeve operatively connected to said hair scraping element to function as said covering element, wherein when said hair scraping element is driven to move, said extension sleeve is driven to move, so as to switch said air pressure adjusting port between said blocked state and said unblocked state.

13. The pet hair comb according to claim 12, wherein said extension sleeve is integrally extended from said hair scraping element.

14. The pet hair comb according to claim 1, wherein said pet hair comb further comprises an operational driving assembly for driving said relative movement between said hair scraping assembly and said grooming assembly, wherein said said operational driving assembly comprises an operation element, and said air pressure adjusting port is provided in said operation element.

15. The pet hair comb according to claim 2, wherein said pet hair comb further comprises a covering element, said operational driving assembly is operatively connected to said covering element to allow said covering element to be switched between said blocked state in which said covering element covers said air pressure adjusting port to block said air pressure adjusting port from communicating with said air duct and said unblocked state in which said covering element is spaced apart from said air pressure adjusting port for allowing said air pressure adjusting port to be communicated with said said air duct.

16. The pet hair comb according to claim 15, wherein said covering element is located on an outside or inner side of said air pressure adjusting port.

17. The pet hair comb according to claim 2, wherein said hair scraping element is located on a front side of said installation base, and said hair scraping element has a plurality of needle holes corresponding to said plurality of grooming needles allowing said grooming needles to pass therethrough respectively.

18. The pet hair comb according to claim 17, wherein said installation shell body comprises an installation head and a gripping part connected to said installation head, wherein said installation head has a head cavity, and said gripping part has a hollow cavity in communication with said head cavity, wherein said installation base is installed on said installation head and has a through hole, wherein the pet hair comb further comprises an extension sleeve extended rearward from said hair scraping element, wherein said extension sleeve passes through said through hole of said installation base and extended into said head cavity.

19. The pet hair comb according to claim 2, wherein said installation base has a through hole, and said hair scraping element is arranged at a position corresponding to said through hole of said installation base, wherein when said hair scraping element is in said second state, said hair scraping element is extended out of said through hole of said installation base.

20. A hair removing method by a pet hair comb, comprising the following steps:
(a) maintaining a negative pressure state in an air duct of said pet hair comb; and
(b) switching an air pressure adjusting port between an unblocked sate in which said air pressure adjusting port communicates said air duct to an outer side and a blocked state in which said air pressure adjusting port is blocked from communicating said air duct to the outer side, so as to adjust an air pressure in said air duct.
